(19) United States
(12) Patent Application Publication
(10) Pub. No.: US 2026/0320320 A1
(43) Pub. Date: Oct. 15, 2026

(54) DEVICE AND SYSTEMS FOR ENABLING COMMUNICATION WITH EXTERNAL DEVICES AND SERVER SYSTEM AND PROVIDING RECOMMENDATION TO A USER

(71) Applicant: Avery Dennison Retail Information Services LLC, Mentor, OH (US)

(72) Inventors: Frederick BLECKMANN, Barrington, NH (US); Erik SCHUMANN, Fellbach (DE); Kristen MUNROE, Toronto (CA); Michael GOLLER, Graz (AT)

(21) Appl. No.: 19/476,226

(22) PCT Filed: May 31, 2024
(86) PCT No.: PCT/IB2024/055358

§ 371 Date: Oct. 17, 2025

Related U.S. Application Data
(60) Provisional application No. 63/505,596, filed on Jun. 1, 2023.

(51) Int. Cl. G06K 7/10; G06K 7/00; G06K 19/077

(52) U.S. Cl. CPC G06K 7/10297; G06K 7/0008; G06K 19/07758

(57) ABSTRACT

The present subject matter provides a communication device, a server system, and a system for enabling at least one of an interrogation, an interception, a coordination, or a communication between a transmit-receive unit, and the server system or external devices or both by using one or more command signals. The transmit-receive unit is configured to communicate with the server system and external devices using at least one of a Radio Frequency (RF) communication protocol, or a communication network, or a combination thereof. The transmit-receiver unit comprises a transmitter and a receiver. The server system generates recommendations in real-time using a recommendation engine based on received extracted information and digital signature from the communication device via the communication network. The server system is configured to transmit the generated recommendation to the communication device. The system comprises the communication device and the server system.

### FIELD

The present subject matter relates to the field of consumer-based or consumer-used handheld mobile devices and recommendation systems. More specifically, it pertains to a system designed for enabling communication with external devices and a server system, and for providing recommendations to users.

### BACKGROUND

Conventionally, recommendations have been primarily associated with online platforms such as E-commerce platforms, where recommendation engines analyze user data and provide personalized product suggestions. Alternatively, recommendations in offline platforms such as retail stores were provided through various methods on big screens or displays. These displays were strategically placed within the store to attract customer attention and provide product recommendations. However, offline shopping experiences, such as brick-and-mortar stores, have not fully utilized the potential of recommendation systems to provide personalized recommendations to in-store customers/shoppers to enhance customer experiences and facilitate decision-making. Further, offline shopping setup requires more hardware setup such as the installation of a high number of fixed read points spaced around a facility to read digital triggers (such as RFID tags) to collect item level digital inventory.

There exists a need for improved low cost read point in every consumer pocket.

There exists a need for consumer-used or consumer-based devices that can read one or more digital triggers on a product to obtain the EPC or other product data and provide personalized recommendations to a user to improve user engagement and satisfaction.

### BRIEF DESCRIPTION OF THE DRAWINGS

The summary above, as well as the following detailed description of illustrative embodiments, is better understood when read in conjunction with the appended drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following diagrams wherein:

FIG. 1 shows an exemplary environment in accordance with an embodiment;

FIG. 2 is a schematic showing components of a system in accordance with an embodiment;

FIGS. 3A-3C illustrate exemplary User Interfaces (UIs) that depict consumer engagement while performing shopping in accordance with an embodiment;

FIG. 4 illustrate exemplary UI which depicts recommendations to the user in accordance with an embodiment; and

FIGS. 5A-5D show example environments for enabling communication with external devices and a server system, and providing recommendations to a user in accordance with an embodiment.

In the accompanying drawings, an underlined number is employed to represent an item over that the under lined number is positioned or an item to that the under lined number is adjacent. A non-underlined number relates to an item identified by a line linking the non-underlined number to the item. When a number is non-underlined and accompanied by an associated arrow, the non-underlined number is used to identify a general item at that the arrow is pointing.

### SUMMARY

The following presents a general summary in order to provide a basic understanding of some aspects of the disclosed innovation. This summary is not an extensive overview, and it is not intended to identify or limit key/critical elements or to delineate the scope thereof. Its sole purpose is to present some concepts in a general form as a prelude to the more detailed description that is presented later.

In some embodiments, a communication device includes a transmit-receive unit, a software controller, and an application installed therein. The transmit-receive unit is configured to communicate with a server system and external devices using at least one of a Radio Frequency (RF) communication protocol, or a communication network, or a combination thereof. The transmit-receive unit comprises a transmitter and a receiver. The software controller is configured to perform at least one of an interrogation, an interception, a coordination, or a communication between the transmit-receive unit, and the server system or external devices or both by using one or more command signals. The external device includes at least one digital trigger and a Radio Frequency Identification (RFID) reader.

In some embodiments, a server system is communicatively coupled with a communication device to provide recommendations to a user on the communication device. In some embodiments, the server system comprises an Input/Output (I/O) interface, a recommendation engine, a processor, and a memory communicatively coupled with the processor. The I/O interface is configured to communicate with the communication device via a communication network. The processor is configured to receive extracted information and digital signature data related to each of one or more products from a software controller via an application installed in the communication device through the communication network. The processor is configured to identify each of the one or more products associated with the received extracted information by accessing a database associated with the server system. The processor is configured to generate a recommendation to the user in real-time using the recommendation engine. The processor is configured to transmit the generated recommendation to the communication device

In some embodiments, a system includes a communication device and a server system. In some embodiments, the communication device, the RFID reader, and the at least one digital trigger, such as an RFID tag, are operatively coupled to each other and are configured to operate in a particular RF threshold frequency range.

### DETAILED DESCRIPTION

The following detailed description illustrates various embodiments of the present subject matter and ways in which they may be implemented. Although some modes of carrying out the present subject matter have been disclosed, those skilled in the art will recognize that other embodiments for carrying out or practicing the present subject matter are also possible. Some disclosed embodiments include a communication device, a server system, and/or a system for enabling communication with external devices and a server system, and providing recommendations to a user.

### I. Definitions

“Modulation signal frequency” as used herein refers to a frequency at which the modulation signal is generated and applied to the carrier signal, enabling the encoding of information onto the carrier signal for transmission in a communication system.
“RFID” as used herein refers to radio frequency identification devices.
“Software controller” as used herein refers to a component or program that controls and manages the operation of a communication device and also manages/controls the operations between the communication device and other devices such as server system, an RFID reader, and at least one digital trigger.

These and other features, aspects, embodiments, and advantages of the present subject matter will be better understood with reference to the below stated description and appended claims. These definitions are provided to introduce a selection of concepts in a simplified form. These definitions are not intended to identify key features or essential features or key words of the claimed or disclosed subject matter, nor is it intended to be used to limit the scope of the claimed subject matter.

The communication device, a server system, and a system disclosed herein are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. may be made and may be desired for a specific application.

### II. Overview

In some embodiments, the present subject matter relates to a communication device, a server system, and a system for enabling at least one of an interrogation, an interception, a coordination, or a communication between a transmit-receive unit and a server system or external device, or both, by using one or more command signals. The transmit-receive unit is configured to communicate with a server system and external devices using a Radio Frequency (RF) communication protocol, a communication network, or a combination thereof. The transmit-receiver unit comprises a transmitter and a receiver.

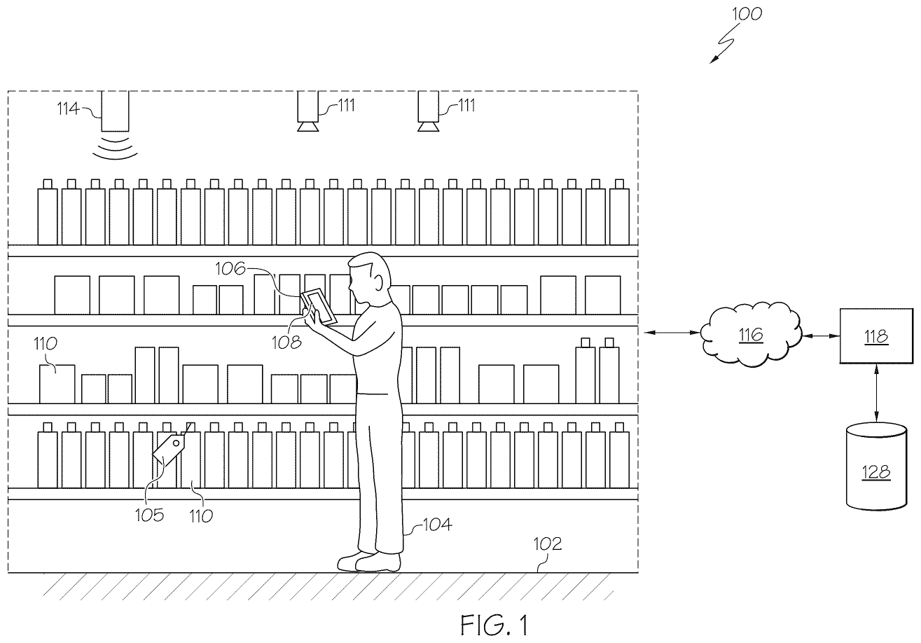

FIG. 1 shows an exemplary environment 100 that enables at least one of an interrogation, an interception, a coordination, or a communication between a communication device 106, and external devices such as an RFID reader 114 and at least one digital trigger 105 or a server system 118 or both, and provides recommendations to a user 104, in accordance with an embodiment. The exemplary environment 100 comprises one or more components including, but not limited to, the communication device 106, the external devices, the server system 118, a communication network 116, and a database 128. For example, the exemplary environment 100 may be a retail store 102, as shown in FIG. 1, a medical facility, a home environment, and the like. The retail store 102 may include, for example, a product 110, the external devices, one or more monitoring cameras 111, the user 104, and the communication device 104. The at least one digital trigger 105 comprises an RFID tag. The RFID reader 114 may be, for example, an Electronic Product Code (EPC) exciter, an overhead reader, a tunnel reader, or a handheld reader. The at least one digital trigger 105 is associated with, adhered to, or attached to the product 110 to enable detection by the communication device 106. The product 110 may be any type of product that can be sold in a retail store (e.g., electronic items, apparel, pharmaceuticals, cosmetic items, medicine, food, beverage, and other consumer goods, etc.).

Further, the communication device 106 may be, for example, a mobile phone, a smart phone, a tablet, a laptop, handheld computer, a computer, or a smart watch. The communication device 106, the RFID reader 114, and the at least one digital trigger 105 (for example, the RFID tag) are operatively coupled to each other and are configured to operate at a particular frequency range. The one or more monitoring cameras 111 are configured to capture and track store operations. For example, one or more monitoring cameras 111 may capture store's planogram images, shelf's images with location, and images of the store floors.

The communication device 106 is configured to communicate with the external devices using at least one Radio Frequency (RF) communication protocol. For example, the RF communication protocol may be a Gen2 Ultra High Frequency (UHF) communication protocol. The communication device 106 is configured to communicate with the server system 118 through the communication network 116 via an application using one or more Application Program Interfaces (APIs). The communication network 116 may include, without limitation, a direct interconnection, Local Area Network (LAN), Wide Area Network (WAN), cellular network, wireless network (e.g., using Wireless Application Protocol), the Internet, Ultra-Wide Band, etc.

The server system 118 is configured to communicate with the communication device 106 via the communication network 116 to provide recommendations to the user 104. The user 104 may be, for example, a customer, or an employee, a consumer, a shopper, a buyer, a client, or a purchaser.

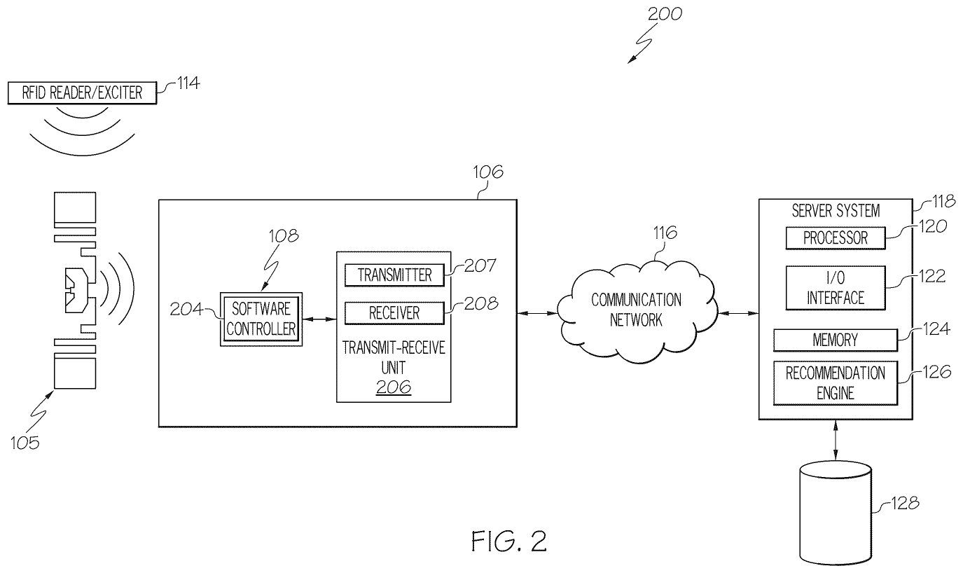

FIG. 2 shows the components of a system 200, in accordance with an embodiment. The system 200 includes the communication device 106, the external devices such as the RFID exciter 114 and the at least one digital trigger 105, the server system 118. The communication device 106 includes, for example, a transmit-receiver unit 206, and a software controller 204, the latter of which runs an application 108.

### III. Transmit-Receive Unit

In one embodiment, a transmit-receive unit 206, via an antenna (not shown in FIG. 2), is configured to communicate with the server system 118 and external devices using the RF communication protocol, the communication network 116, or a combination thereof. The transmit-receive unit 206 which further includes a transmitter 207 and a receiver 208. The receiver 208 is configured to intercept one or more RF signals from the external devices 105 and 114 via the Gen2 UHF communication protocol.

The one or more RF signals comprises a query signal and a response signal. The receiver 208 intercepts the query signal, which is generated by the RFID exciter 114, and the receiver 208 also intercepts the response signal, which is generated by the at least one digital trigger 105 in response to the query signal when the RFID exciter 114 interrogates the at least one digital trigger 105. Further, the receiver 208 receives a recommendation from the server system 118 via the communication network 116, as will be discussed below.

In an alternative embodiment, the receiver 208 intercepts the response signal, which is generated by the at least one digital trigger 105 in response to the query signal when transmitter 207 transmits/emits RF signal to interrogate or query the at least one digital trigger 105 using a Gen2 UHF communication protocol. Further, the transmitter 207 also transmits extracted information and digital signature data to the server system 118 via the communication network 116.

### IV. Software Controller

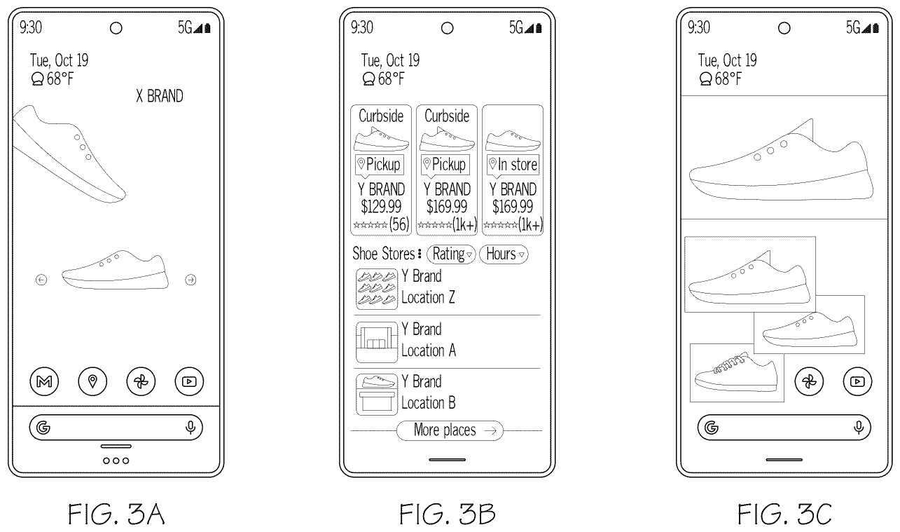

The communication device 106 described herein further contains the software controller 204 shown in FIG. 3 which is configured to perform the interrogation, interception, coordination, and communication between the transmit-receive unit 206 and the server system 118, or the external devices, or both, by utilizing the application 108 via one or more command signals. In an example embodiment, the software controller 204 may be implemented in hardware, software, or a combination thereof. In one embodiment, the software controller 204 is integrated with the application 108 in order to establish communication with the server system 118 using the one or more command signals via the communication device 106. In another embodiment, the software controller 204 is standalone entity that operates with the server system 118 via the application 108 using the one or more command signal. The software controller 204 is also configured to modify or tune functionality of the receiver 208 and/or the transmitter 207 to operate at a particular RF threshold frequency range by leveraging one or more software algorithms to operatively couple with the RFID reader 114 and the at least one digital trigger 105. The communication device 106, the RFID reader 114, and the at least one digital trigger 105 are operatively coupled to each other and are configured to operate at a particular RF threshold frequency range. In some implementations, the particular RF threshold frequency is within the range of a defined RF threshold frequency for the antenna. In one embodiment, the software controller 204 is configured to identify a modulation signal frequency between the communication device 106 and the at least one digital trigger 105 and the exciter/reader 114. Based on the identified modulation signal frequency, the software controller 204 is configured to tune the particular RF threshold frequency of the antenna to work in accordance with the identified modulation signal frequency. For example, if the defined threshold frequency range is 902-928 MHz the software controller will search within this range for the modulation signal frequency. When the software controller identifies the modulation signal frequency is, for example, 915 MHz, then the software controller 204 then tunes the antenna to 915 MHz to work in accordance with the identified modulation signal frequency. The defined threshold frequency being in the range of 902-928 MHz is only an example and should not be considered as a limitation.

The software controller 204 is configured to intercept, via the receiver 208, the one or more RF signals such as a query signal and a response signal from the RFID reader 114 and the at least one digital trigger 105, respectively, when the RFID exciter 114 interrogates the at least one digital trigger 105. The software controller 204 is configured to demodulate the intercepted one or more RF signals to extract information and digital signature data associated with each of the one or more RF signals by leveraging the one or more software algorithms. The extracted information comprises, for example, an Electronic Product Code (EPC), an RFID reader name, a command sent to the at least one digital trigger 105, a signal strength of the RFID reader 114, a TID (Trade Identification Number), product name, product type, product price, production date, item level information, other product-specific information, or brand authentication information. In an embodiment, the product information would relate to the product 110 to which the at least one digital trigger 105 is affixed or installed. The digital signature data comprises a read rate count and a signal strength related to the at least one digital trigger 105, which is affixed or attached to the product 110. The software controller 204 is configured to generate the digital signature data by determining the read-rate count and signal strength. The read-rate count of the at least one digital trigger 105 is determined by measuring the number of times the at least one digital trigger 105 is read by the receiver 208 of the communication device 106 at a particular RF threshold frequency.

The signal strength is determined by measuring a power or amplitude of an RF signal of the at least one digital trigger 105 received by the receiver 208 over a specific time period. For example, as the read-count and the signal strength increases a consumer interest score increases. For instance, the communication device 106 may continuously measure the power or amplitude of the one or more RF signals of the RFID tag over a specific time period. As the number of times read count increase the read-rate count increases. For example, consider a specific time period of 5 microseconds. In one example, in a 5 microsecond period, the communication device 106 may measure higher power or higher amplitude (for example, 64 dBm (decibels-milliwatt)) from an RF signal of the RFID tag when the communication device 106 is near the RFID tag 105. In another 5 microsecond period, the communication device 106 may measure low power or low amplitude (for example 20 dBm) from the RF signal of the RFID tag when the communication device 106 is away from the RFID tag. If the RF signal of the RFID tag has a high power or amplitude it will provide a higher signal strength, and vice-versa. The higher power 64 dBm and the lower power 20dBm are only examples and should not be considered as a limitation.

The software controller 204 is configured to transmit the extracted information and the digital signature data to the server system 118 using the application 108 via the communication network 116. The software controller 204 is configured to receive recommendations from the server system 118 using the application 108 via the communication network 116. The software controller 204 is configured to display the recommendation to the user 104 on a user interface associated with the communication device 106. The recommendation may comprise, for example, a price discount on the product 110, style options, in-store availability of the product, the product image, promotions related to the product, list of products based on recently viewed products online, notifications, product color, coupons or other promotional offers, or identical or similar product options when the product is not available.

Further, the one or more command signals may include a) a signal for converting each of the one or more RF signals between analog and digital, b) a signal for tuning the receiver to receive each of the one or more RF signals in one or more targeted Radio Frequency bands produced by an interrogated RFID tag, c) a signal for intercepting each of the one or more RF signals in one or more targeted radio frequency (RF) bands by an interrogated RFID tag, d) a signal for demodulating the received each of the one or more RF signals to extract information and digital signature data, e) a signal for transmitting the extracted information and the digital signature data to the server system 118 via the communication network 116, f) a signal for receiving the recommendation from the server system 118 via the communication network 116, and g) a signal to process, store, transmit, receive, display or input data, or to perform a specific function between the communication device 106 and any or both of the external devices and the server system 118. In one embodiment the specific function includes, for example, modifying an RF threshold frequency of the receiver and/or transmitter, RF filtering and signal conditioning at certain frequencies under a selected RF threshold frequency, equalization and correction for multipath effects, or any combination thereof.

### V. Server System

In an embodiment, the server system 118 is communicatively coupled with the communication device 106 via the communication network 116 to provide recommendations to the user 104 on the user interface associated with the communication device 106. The server system 118 includes, but is not limited to, at least one Central Processing Unit (also referred to as “CPU” or “processor”) 120, an Input/Output (I/O) interface 122, a recommendation engine 126, the database 128, and a memory 124 for storing instructions executable by the processor 120. The memory 124 is communicatively coupled to the processor 120. The memory 124 stores instructions, executable by the processor 120, which, on execution, may cause the server system 118 to generate recommendations in real-time to the user 104, as disclosed in the present subject matter. The I/O interface 122 is coupled with the processor 120 through which data is transmitted and received. The processor 120 is configured to receive extracted information and the digital signature data from the communication device 106 via the I/O interface 122. The processor 120 is also configured to identify products associated with the received extracted information by accessing the database 128 associated with the server system 118.

The database 128 stores information relating to the store and its contents including, for example, the store's planogram information, shelf images with location information, geospatial information, user history, images of the store floors, location of the communication device(s), Electronic Product Code (EPC) lookup table, information about products sold in the store, and information about products located on the store's shelves. The EPC lookup table consists of a plurality of EPCs. Each of the plurality of EPCs corresponds to, for example, a specific product name, description, price, category, size, color, weight, or a combination thereof. The processor 120 is configured to access the EPC lookup table stored in the database 128 based on the extracted EPC codes from the received extracted information. The processor 120 is configured to identify each of the one or more products by identifying each of the extracted EPC codes in the lookup table. The EPC lookup table may be updated in real-time, or on a periodic or as-needed basis.

The processor 120 also instructs the application 108 to add the one or more products into a digital cart associated with the application based on identifying each of the one or more products by using the database, the extracted information, and the digital signature data. In an embodiment, the processor 120 is configured to generate an interest score for each of the one or more products based on an analysis of the received digital signature data using one or more algorithms. The interest score may be represented in the form of a numerical value or a percentage. For instance, if the read-rate count and the signal strength are high, the interest score may be high because the interest score is directly dependent on the read-rate count and the signal strength. In one example, if the read-rate count is 40 and the signal strength is 64 dBm, then the interest score may be 80%. In another example, if the read-rate count is 10 and the signal strength is 24 dBm, then the interest score may be 30%. The values provided in these examples are only examples and should not be considered to be limiting. The interest score of each of the one or more products is used by the processor to determine what the customer or user 104 is expected to have in the digital cart during the self-checkout process. For example, the higher interest score products are retained in the digital cart from the one or more products and low interest score products are dropped from the digital cart.

Further, the processor 120 is configured to generate one or more recommendations in real-time to the user 104 using the recommendation engine 126. The processor 120 operatively communicates with the recommendation engine 126. The processor 102 collects data from any or both of the incoming requests and the database 128. The data includes the extracted information, the digital signature data, identified products data, and user history (e.g., user preferences, user historical purchases, online browsing data, recently viewed items online, or purchase behavior). The processor 120 sends the collected data to the recommendation engine 126 for analysis.

The recommendation engine 126 receives the data from the processor 120 and applies its recommendation algorithms, or rules to analyze the data. The analysis of the data involves processing user profiles, item representations, and any other relevant data to generate personalized recommendations. Any other relevant data may include, but is not limited to, the location of the communication device 106, shelf location, store floor location, user historical purchases, user's online browsing data, recently viewed items online or purchase behavior of the user 104. In an embodiment, the recommendation engine 126 is a rule-based engine or a machine learning engine. The recommendation engine 126 employ a rule-based or a machine learning technique to continuously learn from user interactions and improve the recommendation quality. As more data is collected, the recommendation engine adapts, refines and generates its recommendations to better suit individual user 104 preferences.

### VI. Application

In an embodiment, the application 108 that is stored in the communication device 106 or may be downloaded from an application store. The consumer or the user 104 can register on the server system 118 using the application 108. For the registration, the user 104 may need to provide their details such as name, Date of Birth (DoB), phone number, password, email, and the like. Upon successful registration, a profile is created for the user 104. The user 104 can access the server system 118 by, for example, providing a username and password or by using another authentication method as is known in the art. The server system 118 facilitates one or more services to the user 104 based on the received extracted information and the digital signature data. For example, one or more services include but are not limited to, personalized recommendations, a payment transaction facility, a self-checkout facility, and user location-based product recommendations.

FIGS. 3A-3C illustrate exemplary User Interfaces (Uls) that depict consumer engagement while performing shopping, in accordance with an embodiment. The UI shown in FIG. 3A includes multiple icons such as an email icon, map icon, image icon, video play icon and a search bar. In an example embodiment, when the consumer or user 104 searches for a product of his/her choice, e.g., shoes of X brand, in the search bar by accessing the application 108, which directs the user to the UI shown in FIG. 3A. The email icon allows the user 104 to get direct information about the searched product to their email ID. The map icon allows the user 104 to find nearby physical store locations where the searched products are available for purchase, as shown in FIG. 3B. Further, the UI shown in FIG. 3B facilitates the display of locations where searched products are available for purchase. For example, the physical stores are filtered based on the user's location. The user's location is determined based on Global Positioning system (GPS) technology, or any known technology in the art. The image icon, as shown in FIG. 3A, includes at least two functionalities (not shown in FIG. 3A). The first functionality allows the user 104 to view product images or visuals associated with searched product. For example, when user 104 clicks on the image icon the user 104 is able to view searched product images or other visuals associated with the searched products. This feature enables user 104 to get a better understanding of the product's appearance, features, or variations. The second functionality allows user 104 to capture product images, such as shoes, during offline shopping. For example, when the user clicks the image icon with the second functionality, it may trigger a camera associated with the communication device 106 (as shown in FIG. 1) to capture an image of the product such as shoes. When the user 104 takes the image of the product, the image may have other products contained therein. The communication device 106 may intercept other products that are in the image and extract EPCs associated with the other products. The server system 118 receives the extracted EPCs from the communication device 106 and identifies the other products using the database 128 and the location of the communication device 106. The identified other products received by the application 108 are presented to the user 104 is as shown in FIG. 3C. Furthermore, the video play icon may direct the user 104 to a demonstration video of the searched product. The demonstration video may showcase the features, benefits, or usage of the searched product to the user 104.

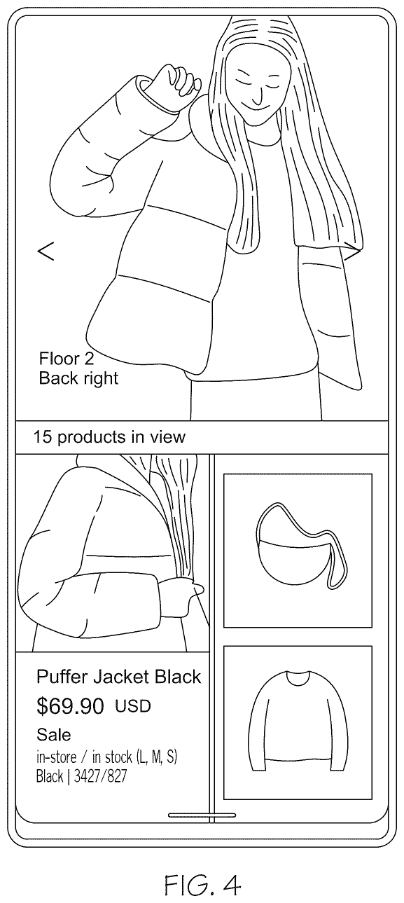

FIG. 4 illustrates an exemplary UI, which depicts a recommendation to the user 104 in accordance with an embodiment. Referring back to FIG. 1 and FIG. 2, the communication device 106 is configured to receive the recommendations from the server system 118. The processor 120 may be configured to display the recommendations to the user 104 on the UI associated with the communication device 106 via the communication network 116. Further, the UI may be configured to display the recommendations in the form of discounts, style options, notifications, product price, product image, product color, status of in-store availability of a selection, coupons or other promotional offers, and identical or similar product options, as shown in FIG. 4.

### EXAMPLES

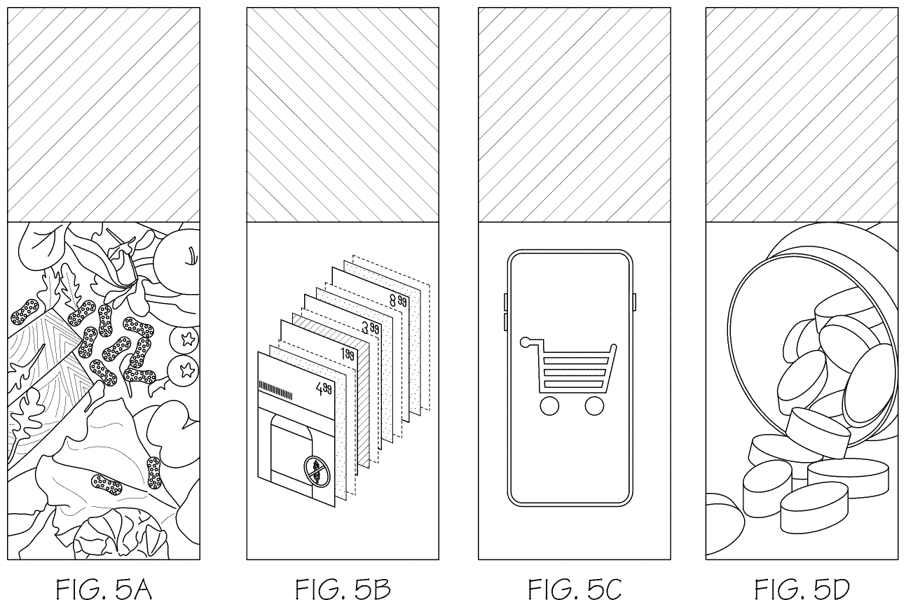

Example 1: FIG. 5A shows an exemplary home environment for enabling an interrogation, interception, coordination, or communication between a transmit-receive unit 206, and a server system 118 or external device, or both, and providing recommendations to the user 104 (as shown in FIGS. 1 and 2). The home environment includes a refrigerator, the communication network 116, server system 118, and the database 128. In an example embodiment, the refrigerator is equipped with an RFID reader 114. The refrigerator includes one or more vegetables. At least one digital trigger 105 is associated with, adhered to, or attached to each of the one or more vegetables. The at least one digital trigger 105 includes an RFID tag or RFID label. The at least one digital trigger 105 may include information about each of the one or more vegetables, such as its product code, type of vegetable, harvest date, expiration date, and the like. The communication device 106 receives/intercept RF signals from the at least one 105 digital trigger associated with the each of one or more vegetables. The communication device 106 extracts the information, which is embedded in the at least one digital trigger 105. The extracted information is transmitted to the server system 118. The server system 118 generates the recommendation using the recommendation engine 126 and the database 128. The database 128 includes the information related to each of the one or more vegetables. The recommendations are displayed on the UI associated with the communication device 104. The recommendations may include, but are not limited to, notifications about the health benefits of each vegetable, nutritional information, and expiration date reminders.

Example 2: FIG. 5B shows an exemplary retail store environment for enabling interception of the external devices (as shown in FIGS. 1 and 2) and providing recommendations to the user 104 on an electronic shelf display. In an example embodiment, the retail store includes a plurality of shelves, and each shelf includes one or more electronic shelf displays. The application 108, which is stored in the communication device 106. The electronic shelf may include a receiver and circuitry and is connected to a replaceable label, which may be a variable/dynamic information display. The communication device 104 sends recommendation data to the shelf edge receiver, which modifies the variable information display accordingly. The application 108 receives the recommendations from the server system 118. The server system 118 provides the recommendation to the application 108 via the communication network 116 (as shown in FIG. 1) based on identifying the received extracted information from the communication device 106. The circuitry on the electronic shelf display device and the application 108 of the communication device 106 work collaboratively to control and manage/modify the variable information display. For instance, the variable information display may provide recommendations based on information received from the at least one digital trigger, or using any or both of the recommendation engine 126 and the database. The recommendations may include price discount, product details, place of product origin, and the like.

Example 3: FIG. 5C shows an exemplary retail store environment for facilitating self-checkout. Referring back to FIG. 1 and FIG. 2, consider the exemplary environment of a retail store 102. The user 104 can perform self-checkout using the application 108 installed in the communication device 106. The communication device 106 and the server system 118 communicate with each other via the communication network 116. The communication device 106 intercepts the at least one digital trigger 105, such as the RFID tag or label, via the RF communication protocol. Consider an example scenario in which a user 104 picks the product 110 from a shelf based on his/her interest while navigating through the retail store 102. The communication device 106 is configured to continuously intercept the RF signals being generated by the at least one digital trigger 105, which is affixed to the product 110. The communication device 106 is configured to extract information and digital signature data based on the interception of the RF signals. The extracted information and digital signature data are transmitted to the server system 118. The server system 118 is configured to generate an interest score for each of the one or more products based on an analysis of the received extracted information and the database 128.

The interest score of each of the one or more products is used by the server system 118 to determine what a customer or the user 104 is expected to have in the digital cart to enable the self-checkout process. In one example, if the interest score is high, such as 95%, then the server system 118 sends an instruction to the application 108 to add the corresponding product into a digital cart associated with the application 108. In another example, if the interest score is low, such as 35%, then the corresponding product is not added to the digital cart. The values provided in these examples are only examples and should not be considered as a limitation. The application 108 facilitates a check-out page e-wallet service directing to an e-wallet application when, for example, the consumer clicks on a check-out option icon (not shown in FIG. 5C) during the check-out process. For example, the e-wallet application may support credit cards, debit cards, or any form of payment.

Example 4: FIG. 5D shows an exemplary medication monitoring system for enabling at least one of an interrogation, an interception, a coordination, or a communication between a transmit-receive unit 206 and a server system 118 or external devices such as an RFID reader 114, at least one RFID tag 105, or both (as shown in FIGS. 1 and 2). This communication may enable the provision of recommendations to a user 104. The RFID reader 114 may be installed in any appropriate location such as, for example, a medical facility, a patient room, a home environment, or the like.

In an example embodiment, a digital trigger 105, such as an RFID tag, is affixed to a medication bottle, or other form of medication packaging. The digital trigger 105 includes information about the medication contained in the bottle or package. The information may include, but is not limited to, a medicine name, dosage instructions, an expiration date, and any other relevant details. The RF signal of the at least one digital trigger attached to the medication bottle or package is intercepted by the communication device 106, which demodulates the received RF signal to extract the information. Further, the extracted information is transmitted to the server system 118 (shown in FIGS. 1 and 2). The server system 118 provides the recommendation to the communication device 106 via the application 108. The user 104, a healthcare provider, a caregiver or the like can go through the recommendation to monitor medication adherence. The recommendations may include, for example, notifications or reminders sent to individuals to take their medication on time.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

1. A communication device comprising:
a transmit-receive unit configured to communicate with a server system and external devices using at least one of a Radio Frequency (RF) communication protocol, or a communication network, wherein the transmit-receiver unit comprises a transmitter and a receiver; and
a software controller,
wherein the software controller is configured to perform at least one of an interrogation, an interception, a coordination, or a communication between the transmit-receive unit and at least one of the server system and external devices or both by using one or more command signals.

2. The communication device of claim 1, wherein the software controller is integrated with an application to establish communication with the server system using the one or more command signal via the communication network.

3. The communication device of claim 1, wherein at least one of the external devices comprise at least one digital trigger.

4. The communication device of claim 1, wherein at least one of the external devices further comprise a Radio Frequency Identification (RFID) reader.

5. The communication device of claim 4, wherein the RFID reader is selected from the group consisting of an Electronic Product Code (EPC) exciter, a handheld reader, and an overhead reader.

6. The communication device of claim 3, wherein the at least one digital trigger comprises an Radio Frequency Identification (RFID) tag.

7. The communication device of claim 2, wherein the software controller, using the one or more command signals, is configured to:
intercept, via the receiver, one or more Radio Frequency (RF) signals from the external devices,
demodulate the one or more RF signals to extract information and digital signature data associated with the each of the one or more RF signals;
transmit, using the application, the extracted information related to the external devices to the server system via the communication network;
transmit, using the application, digital signature data related to at least one digital trigger to the server system via the communication network;
receive, using the application, a recommendation from the server system via the communication network; and
display the received recommendation on a user interface associated with the communication device.

8. The communication device of claim 7, wherein the one or more RF signals comprises a query signal and a response signal.

9. The communication device of claim 8, wherein the query signal is generated by an RFID reader and the response signal is generated by the at least one digital trigger in response to the query signal when the RFID reader interrogates the at least one digital trigger.

10. The communication device of claim 7, wherein the software controller is further configured to:
determine a read-rate count of the at least one digital trigger by measuring the number of times the at least one digital trigger is read by the receiver of the communication device at a specific RF threshold frequency;
determine a signal strength by measuring a power or amplitude of an RF signal of the at least one digital trigger received by the receiver over a specific time period; and
generate the digital signature data based on the determined read rate count and signal strength.

11. The communication device of claim 10, wherein the digital trigger is affixed or attached to a product.

12. The communication device of claim 1, wherein the one or more command signals comprises at least one of:
a signal for converting each of the one or more RF signals between analog and digital,
a signal for tuning the receiver to receive each of the one or more RF signals in one or more targeted Radio Frequency bands produced by an interrogated RFID tag
a signal for intercepting each of the one or more RF signals in one or more targeted radio frequency (RF) bands by an interrogated RFID tag
a signal for demodulating the received each of the one or more RF signals to extract information and digital signature data,
a signal for transmitting the extracted information and the digital signature data to the server system via the communication network,
a signal for receiving the recommendations from the server system via the communication network, or
a signal to perform one of processing of data, storing data, transmitting data, receiving data, displaying data, and inputting data, or performing a specific function between the communication device and any or both of the external devices and the server system.

13. The communication device of claim 12, wherein the specific function comprises one of modifying an RF threshold frequency of the receiver, RF filtering and signal conditioning at frequency under a selected RE threshold frequency, or equalizing and correcting for multipath effects.

14. The communication device of claim 12, wherein the communication device is a consumer device, or-a user device, or a customer device.

15. The communication device of claim 14, wherein the communication device is selected from the group consisting of a mobile phone, a smart phone, a tablet, a laptop, a handheld computer, a computer, and a wearable device.

16. The communication device of claim 7, wherein the extracted information is associated with a product to which the at least one digital trigger is affixed or installed.

17. The communication device of claim 7, wherein the extracted information comprises one of an Electronic Product Code (EPC), an RFID reader name, a command sent to the at least one digital trigger 105, signal strength of the RFID reader, TID (trade identification number), product name, product type, product price, production date, item level information, other product-specific information, or brand authentication information.

18. The communication device of claim 16, wherein the product comprises one of electronic item, apparel, drug packaging, cosmetic, medicine containers, food and beverage products, or consumer goods.

19. The communication device of claim 7, wherein the recommendation comprises at least one of: a price discount on a product, style options, in-store availability of the product, a product image, a promotions related to the product, a list of products based on recently viewed products online, a notifications, product color, a coupons or other promotional offers, or identical or similar product options if the searched product is not available.

20. A server system communicatively coupled with a communication device to provide recommendations to a user on a communication device, the server system comprising:
an Input/Output (I/O) interface configured to communicate with the communication device via a communication network;
a recommendation engine;
a processor; and
a memory communicatively coupled to the processor,
wherein the processor is configured to:
receive, through the communication network, extracted information and digital signature data related to each of one or more products from a software controller via an application installed in the communication device;
identify each of the one or more products associated with the received extracted information by accessing a database associated with the server system;
generate a recommendation in real-time to the user using the recommendation engine; and
transmit the generated recommendations to the communication device.

21. The server system of claim 20, wherein each of the one or more products bears at least one digital trigger which can be detected by the communication device.

22. The server system of claim 20, wherein the processor is configured to instruct the application to add the one or more products into a digital cart associated with the application based on identifying each of the one or more products by using the database, received extracted information, and the digital signature data.

23. The server system of claim 20, wherein the database stores at least one of store's planogram information, shelf image with location, geospatial information, user history, images of the store floors, location of the communication device, Electronic Product Code (EPC) lookup table, information about products sold in the store, or products stored in the shelves.

24. The server system of claim 20, wherein the processor is configured to generate an interest score for each of the one or more products based on analyzing the received digital signature data.

25. The server system of claim 24, wherein the interest score of each of the one or more products is used by the processor to determine what a customer or the user is expected to have in the digital cart to enable a self-checkout process.

26. The server system of claim 25, wherein the interest score is represented in the form of a numerical value or a percentage.

27. The server system of claim 23, wherein the Electronic Product Code (EPC) lookup table comprises a plurality of Electronic Product Codes, wherein each of the plurality of Electronic Product Codes corresponds to one of a specific product name, descriptions, prices, category, product size, product color, or product weight,

28. The server system of claim 20, wherein the database is updated in real time.

29. The server of claim 23, wherein the user history comprises one of user historical purchase, online browsing data, user preferences, purchase behavior or recently viewed items online.

30. (canceled)

31. (canceled)
